(19) United States
(12) Patent Application Publication
(10) Pub. No.: US 2025/0184663 A1
(43) Pub. Date: Jun. 5, 2025

(54) AUDIO PROCESSING METHOD AND APPARATUS, STORAGE MEDIUM, AND ELECTRONIC DEVICE

(71) Applicant: Beijing Zitiao Network Technology Co., Ltd., Beijing (CN)

(72) Inventors: Xianjun Xia, Sydney (AU); Mingshuai Liu, Beijing (CN); Yijian Xiao, Beijing (CN)

(21) Appl. No.: 18/961,833

(22) Filed: Nov. 27, 2024

(30) Foreign Application Priority Data
Nov. 30, 2023 (CN) 202311631175.8

(51) Int. Cl. H04R 3/02

(52) U.S. Cl. CPC H04R 3/02; H04R 2460/01

(57) ABSTRACT

Embodiments of the present disclosure provide an audio processing method and apparatus, a storage medium, and an electronic device. The method includes: acquiring audio to be processed, and obtaining first restored audio by restoring, based on a first processing model, a first type of distortion in the audio to be processed; and obtain second restored audio by restoring, based on a second processing model, a second type of distortion in the first restored audio.

### CROSS-REFERENCE TO RELATED APPLICATION(S)

This application claims priority to Chinese Application No. 202311631175.8 filed Nov. 30, 2023, the disclosure of which is incorporated herein by reference in its entirety.

### FIELD

Embodiments of the present disclosure relate to the audio processing technology, and in particular, to an audio processing method and apparatus, a storage medium, and an electronic device.

### BACKGROUND

Real-time communication has become a commonly used communication method in modern society, with audio communication as an important communication method of the real-time communication.

### SUMMARY

The present disclosure provides an audio processing method and apparatus, a storage medium, and an electronic device. Through two restoration stages, comprehensive restoration is performed on audio data to be processed so as to improve an audio restoration effect.

In a first aspect, an embodiment of the present disclosure provides an audio processing method, including:
acquiring audio to be processed, and obtaining first restored audio by restoring, based on a first processing model, a first type of distortion in the audio to be processed; and
obtaining second restored audio by restoring, based on a second processing model, a second type of distortion in the first restored audio.

In a second aspect, an embodiment of the present disclosure further provides an audio processing apparatus, including:
a first restoration module, configured to acquire audio to be processed, and obtain first restored audio by restoring, based on a first processing model, a first type of distortion in the audio to be processed; and
a second restoration module, configured to obtain second restored audio by restoring, based on a second processing model, a second type of distortion in the first restored audio.

In a third aspect, an embodiment of the present disclosure further provides an electronic device, where the electronic device includes:
one or more processors; and
a storage apparatus, configured to store one or more programs, and
the one or more programs, when executed by the one or more processors, cause the one or more processors to implement the audio processing method according to any embodiment of the present disclosure.

In a fourth aspect, an embodiment of the present disclosure further provides a storage medium including computer-executable instructions. The computer-executable instructions, when executed by a computer processor, are used to perform the audio processing method according to any embodiment of the present disclosure.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of an audio processing method according to an embodiment of the present disclosure;

FIG. 2 is a schematic diagram of a structure of a time domain restoration model according to an embodiment of the present disclosure;

FIG. 3 is a schematic diagram of a structure of a frequency domain restoration model according to an embodiment of the present disclosure;

FIG. 4 is a schematic diagram of a structure of a second processing model according to an embodiment of the present disclosure;

FIG. 5 is a schematic diagram of a structure of an audio processing apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different orders and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data (including but not limited to the data itself, and data acquisition, or usage) involved in the technical solutions should comply with the requirements of the corresponding laws and regulations, and relevant stipulations.

In the process of audio acquisition and transmission, various factors may lead to audio distortions, thereby reducing the audio quality. Noise is a significant factor causing audio distortions. Currently, a noise reduction model may be used to perform noise reduction processing on audio, so as to reduce influences of the noise on the audio quality. However, noise is only one of the factors influencing audio distortions, and noise reduction processing on the audio cannot fully restore distorted audio.

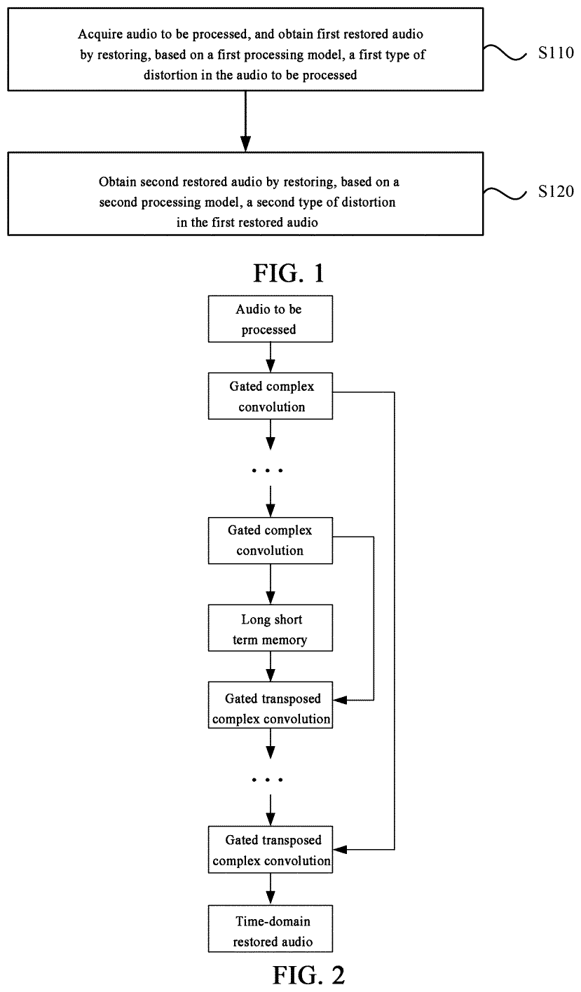

FIG. 1 is a schematic flowchart of an audio processing method according to an embodiment of the present disclosure. This embodiment of the present disclosure is applicable to a case of performing staged restoration on audio to be processed. The method may be performed by an audio processing apparatus. The audio processing apparatus may be implemented in the form of software and/or hardware, and is optionally implemented through an electronic device. The electronic device may be a mobile terminal, a personal computer (PC) terminal, a server, or the like.

As shown in FIG. 1, the method includes:
S110: Acquire audio to be processed, and obtain first restored audio by restore, based on a first processing model, a first type of distortion in the audio to be processed.
S120: Obtain second restored audio by restoring, based on a second processing model, a second type of distortion in the first restored audio.

The audio to be processed is distorted audio data, and may include, but is not limited to, audio data of an audio communication service in a real-time communication scenario, audio data of a video communication service in the real-time communication scenario, audio data in a live streaming scenario, etc.

In some embodiments, the audio to be processed may be audio data received by a playback terminal, and after the audio to be processed is restored, the restored audio may be locally stored, or is played. Correspondingly, the playback terminal performs the audio processing method in this embodiment. In some embodiments, a server receives audio to be processed from an audio acquisition terminal, and after restoring the audio to be processed, the restored audio may be stored in the server. Alternatively, after receiving a playback request from the playback terminal, the restored audio is pushed to the playback terminal. Alternatively, the restored audio is transmitted to the playback terminal based on a playback terminal identifier carried by the audio to be processed. Correspondingly, the server performs the audio processing method in this embodiment.

According to this embodiment of the present disclosure, the first processing model restores the first type of distortion in the audio to be processed, and the second processing model restores the second type of distortion in the first restored audio output by the first processing model, thereby obtaining the restored audio. Through the two-stage restoration process, comprehensive distortion restoration is performed on the audio to be processed, thereby improving the audio quality. Meanwhile, the different processing models are respectively used in the two stages to perform the restoration on the first type of distortion and the second type of distortion, thereby reducing the difficulty of one-time restoration, and reducing the model development cost while improving the audio quality.

It should be understood that when the audio to be processed is audio data in audio and video data, the audio data in the audio and video data is extracted as the audio to be processed, and after restoring the audio to be processed, the restored audio data and video data are combined to obtain restored audio and video data.

In the process of audio acquisition and transmission, various factors may lead to audio distortion in the audio data to be processed. Audio distortion may be categorized into different types. Optionally, there may be two types of audio distortions, including a missing distortion and an additive distortion. The missing distortion refers to a distortion caused by the absence or loss of information in the audio data in the audio acquisition or transmission process, which may be a distortion caused by one or more forms including but not limited to missing frequency bands, packet loss, etc. The additive distortion refers to a distortion caused by interference information added to the audio data in the audio acquisition or transmission process, which includes, but is not limited to, a distortion caused by one or more forms such as noise, reverberation, processing artifacts, etc.

In this embodiment, for different types of distortions, the audio to be processed is restored through different restoration stages. Based on achieving comprehensive restoration of the audio to be processed, a two-stage restoration process, with each stage targeting a type of distortion for restoration, can reduce the processing difficulty of one-time restoration. A processing model is set for each stage through classification, and each processing model restores a type of distortion. Restoring different types of distortions through different processing models can reduce the difficulty of constructing and training the processing models while ensuring an audio restoration effect.

Specifically, the first processing model obtains the first restored audio by performing first-stage restoration on the first type of restoration in the audio to be processed, and the first restored audio is audio data obtained after completing the restoration of the first type of restoration in the audio to be processed, namely audio data without the missing distortion. The first processing model may be a machine learning model such as a neural network model that has a function of restoring the first type of distortion in input audio.

Based on the first-stage restoration, the second processing model obtains the second restored audio by performing second-stage restoration on the second type of restoration in the first restored audio, and the second restored audio is audio obtained after the corresponding restoration on the audio to be processed, that is, the second restored audio is audio data without the above two types of distortions. The second processing model may be the machine learning model such as the neural network model that has a function of restoring the second type of distortion in the input audio.

In some embodiments, the first type of distortion is the additive distortion, and the second type of distortion is the missing distortion. In some embodiments, the first type of distortion is the missing distortion, and the second type of distortion is the additive distortion. Since a new additive distortion may be caused in the first-stage restoration process, by restoring the additive distortion in the second stage, the original additive distortion in the audio to be processed and the additive distortion generated by a first node may be restored, thereby improving restoration comprehensiveness and accuracy and improving the quality of the restored audio.

According to the technical solution provided in this embodiment, the first type of distortion in the audio to be processed is restored through the first processing model, and the second type of distortion in the first restored audio output by the first processing model is restored through the second processing model, thereby obtaining the restored audio. Through the two-stage restoration process, comprehensive distortion restoration is performed on the audio to be processed, thereby improving the audio quality. Meanwhile, the different processing models are respectively used in the two stages to perform the restoration on the first type of distortion and the second type of distortion, thereby reducing the difficulty of one-time restoration, and reducing the model development cost while improving the audio quality.

In some embodiments, quality determination may be performed on the acquired audio to be processed to determine audio quality data, which may be used to represent the audio quality, and the higher audio quality data represents better audio quality and a lower distortion degree. For example, the quality determination may be implemented through an audio quality detection model, and the audio quality detection model may be the machine learning model such as the neural network model, which may be obtained through training based on sample audio and a quality label of the sample audio.

When the audio quality data of the audio to be processed is less than a quality threshold, it is determined that there is a distortion in the audio to be processed, and the process of restoring the audio to be processed is performed. When the audio quality data of the audio to be processed is greater than or equal to the quality threshold, it is determined that there is no distortion in the audio to be processed or the distortion degree of the audio to be processed is within an acceptable range, there is no need to perform the process of restoring the audio to be processed.

Based on the above embodiment, taking the first type of distortion being the missing distortion as an example, the first processing model includes a time domain restoration model and a frequency domain restoration model. The time domain restoration model is connected with the frequency domain restoration model. Output data of the time domain restoration model is used as input data for the frequency domain restoration model. The time domain restoration model is used to restore the first type of distortion in a first frequency band of the audio to be processed, and the frequency domain restoration model is used to restore the first type of distortion in a second frequency band of the audio to be processed. The first frequency band may be a high-frequency band, and the second frequency band may be a low-frequency band. Correspondingly, the time domain restoration model performs frequency band extension on the audio to be processed, thereby restoring the first type of distortion in high-frequency information, namely restoring a missing part of a spectrum. The time domain restoration model has robustness to noise, and may perform preliminary noise reduction on the audio to be processed. The frequency domain restoration model restores the first type of distortion in low-frequency information of the audio to be processed, namely restoring unclear low-frequency harmonics caused by encoding and low-frequency hollows caused by excessive suppression. Similarly, the frequency domain restoration model may perform preliminary noise suppression.

Specifically, an audio waveform of the audio to be processed is segmented through a sliding window, and distinguished audio waveform segments are concatenated in time dimension to obtain input data for the time domain restoration model. The window length of the sliding window may be 20 ms, and the unit movement distance of the sliding window may be 10 ms. The above window length and the above unit movement distance may be set according to requirements and are not limited herein. The above input data is input to the time domain restoration model and is restored through the time domain restoration model to obtain time-domain restored audio. Fourier transform is performed on the time-domain restored audio to obtain frequency-domain data. The frequency-domain data is input to the frequency domain restoration model, and Fourier transform is performed on the obtained restored data to obtain first restored audio.

In some embodiments, the time domain restoration model includes a first encoding module, a first temporal modeling module, and a first decoding module, where the first encoding module includes a plurality of gated convolutions which are sequentially connected, the gated convolution may be a gated complex convolution, and the first decoding module includes a plurality of gated transposed complex convolutions which are sequentially connected. The gated convolutions in the first encoding module are skip-connected to the gated transposed complex convolutions in the first decoding module. For example, the number of the gated convolutions is equal to the number of the gated transposed complex convolutions, such as n. The i^{th} gated convolution is skip-connected to the (n-i+1)^{th} gated transposed complex convolution. The first temporal modeling module may be a Recurrent Neural Network (RNN), a Long Short Term Memory (LSTM), or a Sequential Temporal Convolutional Network (STCM), etc., which is used for global modeling utilizing contextual information. Exemplarily, referring to FIG. 2, FIG. 2 is a schematic diagram of a structure of a time domain restoration model according to an embodiment of the present disclosure.

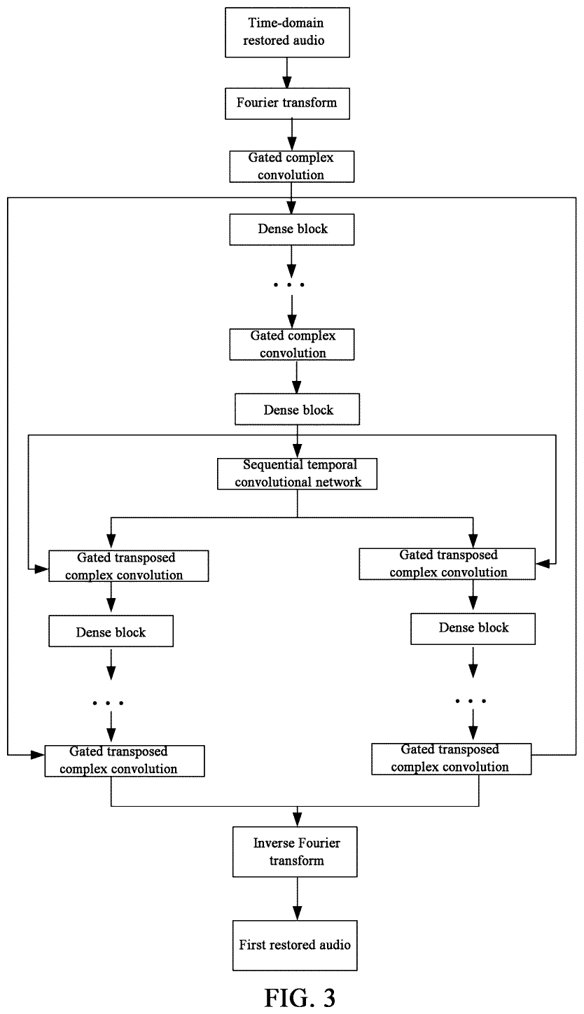

In some embodiments, a frequency domain restoration model includes a second encoding module, a second temporal modeling module, and a second decoding module, where the second encoding module includes a plurality of gated convolutions which are sequentially connected. The second decoding module includes a plurality of gated transposed complex convolutions. For example, the plurality of gated transposed complex convolutions may be arranged in parallel. The second temporal modeling module may include, but is not limited to, the Recurrent Neural Network, the Long Short Term Memory, or the Sequential Temporal Convolutional Network. The gated complex convolutions in the second encoding module are skip-connected to the gated transposed complex convolutions in the second decoding module. When the second decoding module includes two sets of parallel gated transposed complex convolutions, the gated complex convolutions in the second encoding module are respectively skip-connected to the above two sets of parallel gated transposed complex convolutions. As shown in FIG. 3, FIG. 3 is a schematic diagram of a structure of a frequency domain restoration model according to an embodiment of the present disclosure.

Based on the above embodiment, at least part of network layers of the time domain restoration model and/or the frequency domain restoration model are provided with dense connections. Optionally, dense connections are set in the first encoding module and/or the first decoding module in the time domain restoration model. Optionally, dense connections are set in the second encoding module and/or the second decoding module in the frequency domain restoration model. Taking the frequency domain restoration model as an example, referring to FIG. 3, the second temporal modeling module in FIG. 3 is a sequential temporal convolutional network, and both the second encoding module and the second decoding module are provided with the dense connections. In the time domain restoration model and the frequency domain restoration model, the use of the gated complex convolutions may lead to an increased computational load. By setting the dense connections, namely introducing dense blocks, the computational load can be reduced while enhancing the ability of the models to utilize the contextual information.

In this embodiment, the first processing model restores the first type of distortion in features of different frequency bands by combining the time domain restoration model and the frequency domain restoration model.

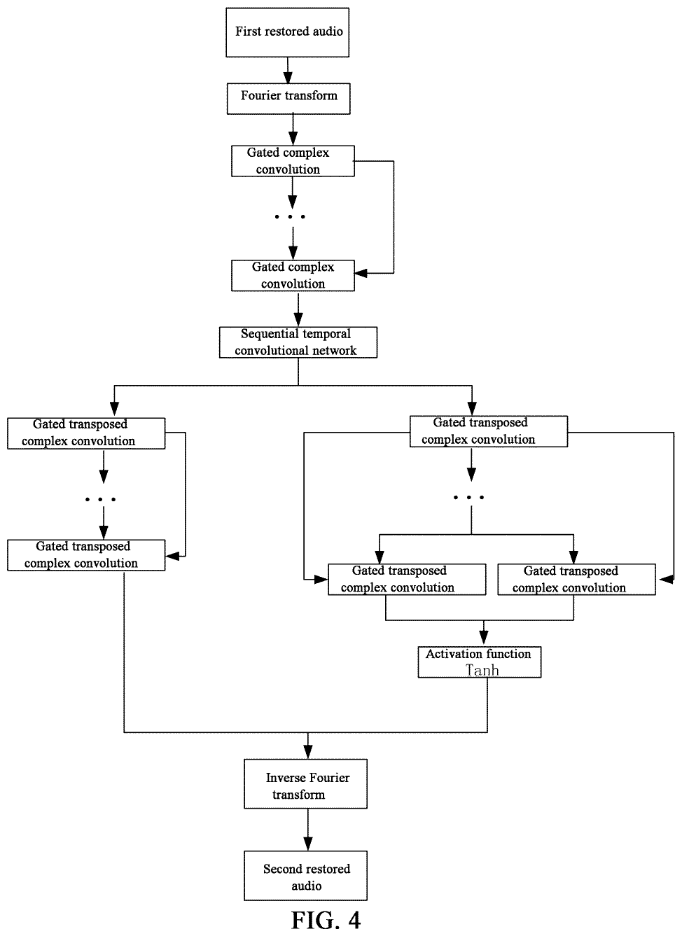

Based on the above embodiment, taking the second type of distortion being the additive distortion as an example, the second processing model includes an encoding module (which may be understood as a third encoding module), a temporal modeling module (which may be understood as a third temporal modeling module), an amplitude decoding module, and a phase decoding module. The temporal modeling module is connected with the encoding module, and the amplitude decoding module and the phase decoding module are respectively connected with the temporal modeling module. As shown in FIG. 4, FIG. 4 is a schematic diagram of a structure of a second processing model according to an embodiment of the present disclosure. The encoding module in the second processing model includes a plurality of gated complex convolutions which are sequentially connected and are skip-connected. For example, the number of the gated complex convolutions is m, and the i^{th} gated complex convolution is skip-connected to the (m-i+1)^{th} gated complex convolution. The temporal modeling module in the second processing model is used to perform global modeling utilizing the contextual information, and may include, but is not limited to, the Recurrent Neural Network, the Long Short Term Memory, or the Sequential Temporal Convolutional Network. The temporal modeling module in FIG. 4 is a sequential temporal convolutional network.

The amplitude decoding module is used to predict an amplitude spectrum of the second restored audio. The amplitude decoding module includes a plurality of gated transposed complex convolutions which are sequentially connected and skip-connected. For example, the number of the gated transposed complex convolutions is 1, and the i^{th} gated transposed complex convolution is skip-connected to the (1-i+1)^{th} gated transposed complex convolution.

The phase decoding module is used to predict a phase spectrum of the second restored audio. The phase decoding module includes a plurality of first gated transposed complex convolutions connected in sequence and second gated transposed complex convolutions arranged in parallel. The second gated transposed complex convolutions arranged in parallel are respectively connected with the plurality of first gated transposed complex convolutions, where the first gated transposed complex convolution at the head is respectively skip-connected to the second gated transposed complex convolutions arranged in parallel; and the other first gated transposed complex convolutions may be skip-connected.

The second processing model in this embodiment is used to remove noise, reverberation, and artifacts produced in the process of processing by the first processing model. Specifically, Fourier transform is performed on the first restored audio to obtain the superimposed amplitude spectrum and phase spectrum, which are input into the second processing module. The second processing model processes the input data to obtain an enhanced amplitude spectrum and an enhanced phase spectrum. Inverse Fourier transform is performed on the enhanced amplitude spectrum and the enhanced phase spectrum to obtain second restored audio.

Based on the above embodiment, both the first processing model and the second processing model are obtained through pre-training. In some embodiments, the first processing model and the second processing model are trained separately. First damaged audio is obtained by performing missing distortion processing on undamaged audio by sample data corresponding to the first processing model. Second damaged audio is obtained by performing additive distortion processing on the undamaged audio by sample data corresponding to the second processing model.

The missing distortion processing may include one or more of the following: randomly dropping packets and randomly eliminating frequency bands for the undamaged audio. The additive distortion processing may include one or more of the following: adding noise, reverberation, and artifacts to the undamaged audio.

The above undamaged audio may be audio data with audio quality data exceeding the quality threshold, or audio data selected through audio quality assessment with audio quality data exceeding the quality threshold, or synthetic audio obtained after processing through an audio synthesis application. A method for acquiring the undamaged audio is not limited herein.

Correspondingly, the process of training the first processing model may include: obtaining the first damaged audio by processing the first type of distortion for the undamaged audio, training the first processing model based on the first damaged audio and the corresponding undamaged audio, adjusting model parameters of the first processing model based on a loss function in the training process, and obtaining the well-trained first processing model when a training termination condition is satisfied. The process of processing the second processing model may include: obtaining the second damaged audio by processing the second type of distortion for the undamaged audio, training the second processing model based on the second damaged audio and the corresponding undamaged audio, adjusting model parameters of the second processing model based on the loss function in the training process, and obtaining the well-trained second processing model when the training termination condition is satisfied.

In some embodiments, both the first processing model and the second processing model are jointly trained. The method for training the first processing model and the second processing model includes: acquiring undamaged audio and processing the first type of distortion and/or the second type of distortion for the undamaged audio to obtain damaged audio; freezing the model parameters of the second processing model, cascading the first processing model and the second processing model, and training the first processing model in a cascade model based on the damaged audio and the undamaged audio; and freezing the model parameters of the trained first processing model, cascading the trained first processing model and the trained second processing model, and training the second processing model in the cascade model based on the damaged audio and the undamaged audio. Optionally, on the basis of freezing the model parameters of the second processing model, the first processing model is iteratively trained through the cascaded first processing model and second processing model which are until a well-trained first processing model is obtained. On the basis of freezing the model parameters of the trained first processing model, the second processing model is iteratively trained through the cascaded trained first processing model and trained second processing model until a well-trained second processing model is obtained. Optionally, the first processing model and the second processing model are alternately trained multiple times. In each alternate training, the model parameters of the second processing model are frozen to train the first processing model, and the model parameters of the first processing model are frozen to train the second processing model. In each alternate training, the first processing model and the second processing model obtained from the previous training are subjected to optimized training.

Based on the above embodiment, the process of training the first processing model includes: obtaining the first processing model by iteratively performing the following training process until the training termination condition is satisfied, freezing the model parameters of the second processing model, and inputting the damaged audio into the cascaded first processing model and second processing model (i.e., the cascade model) to obtain first predicted restored audio output by the first processing model and second predicted restored audio output by the second processing model; generating one or more of the following loss functions based on the first predicted restored audio and/or the second predicted restored audio, as well as the undamaged audio: discrimination loss functions, a generative loss function, a signal-to-noise ratio loss function, and a spectral compression loss function; and adjusting the parameters of the first processing model based on one or more of the discrimination loss functions, the generative loss function, the signal-to-noise loss function, and the spectral compression loss function. The training termination condition includes one or more of the loss of the trained processing model (e.g., the first processing model) reaching a convergence state, the processing accuracy of the trained processing model reaching a preset accuracy requirement, and the number of times of iterative training reaching a preset number.

Herein, the discrimination loss function includes a discrimination loss function corresponding to the first predicted restored audio and/or a discrimination loss function corresponding to the second predicted restored audio. Specifically, a discrimination loss function generation process includes: obtaining discrimination results of the plurality of discriminators by discriminating, based on a plurality of discriminators, the first predicted restored audio and/or the second predicted restored audio, and obtaining a plurality of discrimination loss functions based on the discrimination results of the plurality of discriminators. The plurality of discriminators include at least two of a Multi-Period discriminator, a Multi-Scale discriminator, and a Multi-Frequency Discriminator. By simulating the idea of a generative adversarial network, the first processing model or the cascade model is used as a generator, and the first predicted restored audio or the second predicted restored audio is discriminated through the above discriminators to obtain the discrimination results, and the discrimination loss functions are generated based on the discrimination results.

Exemplarily, the discrimination loss function may be L_{D}=Eₛ[(D(Ŝ)−1)²], where S represents the undamaged audio, Ŝ represents the first predicted restored audio or the second predicted restored audio, and D represents the discriminator. When there are a plurality of discriminators herein, the loss functions generated from the discrimination results of the different discriminators are summed or weighted to obtain the discrimination loss function. In some embodiments, a plurality of first discrimination loss functions are obtained based on the discrimination results of the plurality of discriminators for the first predicted restored audio, and a plurality of second discrimination loss functions are obtained based on the discrimination results of the plurality of discriminators for the second predicted restored audio. The plurality of first discrimination loss functions and the plurality of second discrimination loss functions are weighted to obtain a target discrimination loss function.

The generative loss function is a loss function determined based on the predicted restored audio output by the generator and the undamaged audio when the first processing model or the cascade model is used as the generator, which may be, for example, a loss function obtained based on the first predicted restored audio or the undamaged audio, or a loss function obtained based on the second predicted restored audio or the undamaged audio. The loss function may be a cross-entropy function, a dice function, or the like. Optionally, the generative loss function is determined based on a discrimination result of at least one discriminator for the predicted restored audio output by the generator (i.e., the first predicted restored audio and/or the second predicted restored audio), as well as a discrimination result of the at least one discriminator for the undamaged audio. Exemplarily, the generative loss function may be L_{M}=λ_{G}E_{(x,s)}[(D(Ŝ)−1)²+(D(Ŝ))²], where λ_{G} represents a preset hyperparameter.

The signal-to-noise ratio loss function is determined by calculating a ratio of the undamaged audio to noise in time domain, and for example, is determined based on waveform data of the second predicted restored audio and waveform data of the undamaged audio.

Exemplarily, a method for determining a scale-invariant signal-to-noise ratio loss function may include: performing scale alignment on the waveform data of the second predicted restored audio and the waveform data of the undamaged audio, determining waveform data of noise based on a data difference between the waveform data of the second predicted restored audio and the waveform data of the undamaged audio, and determining the signal-to-noise ratio loss function based on a data ratio of the waveform data of the undamaged audio to the waveform data of the noise. For example, the signal-to-noise ratio loss function may be

$${L}_{SI - SNR} = 10 {log}_{10} \frac{{‖ {S}_{T} ‖}^{2}}{{‖ {S}_{E} ‖}^{2}} ,$$

where S_{T} represents the waveform data of the undamaged audio, namely

$${S}_{T} = \frac{\hat{S} ⊙ S}{{‖ S ‖}^{2}} ,$$

S_{E} represents the waveform data of the noise, namely S_{E}=Ŝ−S_{T}, Ŝ, represents the second predicted restored audio herein, and S represents the undamaged audio.

The spectral compression loss function is determined by calculating a spectrum difference between the restored audio and the undamaged audio in frequency domain, where the restored audio is the second predicted restored audio. For example, the spectral compression loss function is determined based on spectrum data of the second predicted restored audio and spectrum data of the undamaged audio. The spectral compression loss function includes an asymmetric amplitude spectrum loss term, an amplitude spectrum loss term, and a complex spectrum loss term, where the asymmetric amplitude spectrum loss term may be

$${L}_{asym} = \frac{1}{T} {\sum }_{t}^{T} {\sum }_{f}^{F} {\vert h ( {\vert S ( t , f ) \vert}^{0.3} - {\vert \hat{S} ( t , f ) \vert}^{0.3} ) \vert}^{2} ,$$

the amplitude spectrum loss term may be

$${L}_{mag} = \frac{1}{T} {\sum }_{t}^{T} {\sum }_{f}^{F} {\vert {\vert S ( t , f ) \vert}^{0.3} - {\vert \hat{S} ( t , f ) \vert}^{0.3} \vert}^{2} ,$$

and the complex spectrum loss term may be

$${L}_{RI} = \frac{1}{T} {\sum }_{t}^{T} {\sum }_{f}^{F} {\vert {\vert S ( t , f ) \vert}^{0.3} {e}^{j θ S ( t , f )} - {\vert \hat{S} ( t , f ) \vert}^{0.3} {e}^{j θ S ( t , f )} \vert}^{2} .$$

T represents the number of time frames after Fourier transform on the audio data (the undamaged audio or the restored audio), F represents the number of frequency dimensions after the Fourier transform on the audio data, and h is a preset function. Taking the h(x) function as an example, x is input data of the function, h(x)=x when x is greater than or equal to 0, and h(x)=0 when x is less than 0.|S(t,f)|^{0.3}e^{jθS}^{_{(t,f)}} represents an amplitude spectrum obtained after the Fourier transform on the undamaged audio, S(t,f)|^{0.3}e^{jθS}^{_{(t,f)}} represents a complex spectrum corresponding to the undamaged audio, S(t,f) represents the undamaged audio, and Ŝ(t,f) represents the second predicted restored audio. The spectral compression loss function may be obtained by summing an amplitude loss term, a phase loss term, and an intensity loss term.

Optionally, the process of training the second processing model includes: obtaining the second processing model by iteratively performing the following training process until the training termination condition is satisfied: freezing the model parameters of the first processing model, and inputting the damaged audio into the cascaded first processing model and second processing model to obtain second predicted restored audio output by the second processing model; generating one or more of the following loss functions based on the second predicted restored audio and the undamaged audio: discrimination loss functions, a generative loss function, a signal-to-noise ratio loss function, and a spectral compression loss function; and adjusting the parameters of the second processing model based on one or more of the discrimination loss functions, the generative loss function, the signal-to-noise loss function, and the spectral compression loss function. Herein, the discrimination loss function includes a discrimination loss function corresponding to the second predicted restored audio. The process of training the second processing model is the same as the process of training the first processing model, and the method for generating the generative loss function, the signal-to-noise ratio loss function, and the spectral compression loss function is not repeated herein.

In the above embodiment, weighted processing is performed based on more of the discrimination loss functions, the generative loss function, the signal-to-noise ratio loss function, and the spectral compression loss function to obtain the target loss function, and the model parameters of the first processing model or the second processing model may be adjusted based on the target loss function.

The training termination condition for the first processing model or the second processing model may be reaching the convergence state, the preset accuracy requirement, or the preset number of training times in each alternate training.

According to the technical solution in this embodiment of the present disclosure, by training the first processing model and the second processing model, two-stage restoration processing may be performed on the audio to be processed, thereby restoring the different types of restorations on the audio to be processed, and improving the audio quality.

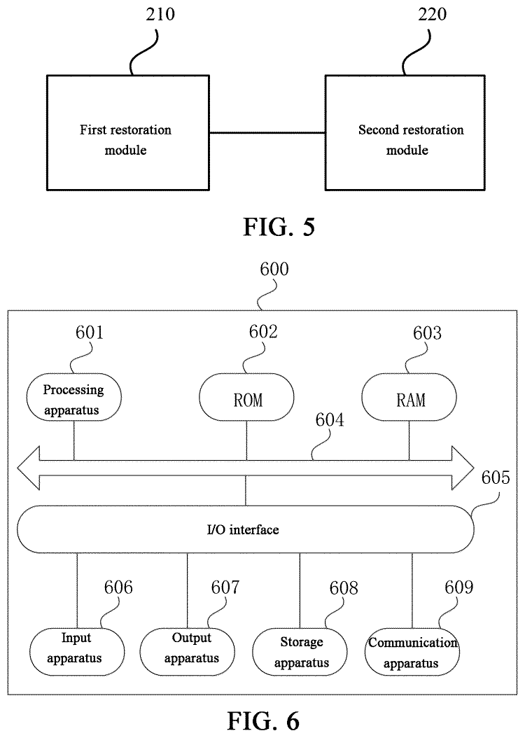

FIG. 5 is a schematic diagram of a structure of an audio processing apparatus according to an embodiment of the present disclosure. As shown in FIG. 5, the apparatus includes: a first restoration module 210 and a second restoration module 220.

The first restoration module 210 is configured to acquire audio to be processed, and restore a first type of distortion in the audio to be processed based on a first processing model to obtain first restored audio; and
the second restoration module 220 is configured to restore a second type of distortion in the first restored audio based on a second processing model to obtain second restored audio.

According to the technical solution provided in this embodiment of the present disclosure, the first processing model restores the first type of distortion in the audio to be processed, and the second processing model restores the second type of distortion in the first restored audio output by the first processing model, thereby obtaining the restored audio. Through the two-stage restoration process, comprehensive distortion restoration is performed on the audio to be processed, thereby improving the audio quality. Meanwhile, the different processing models are respectively used in the two stages to perform the restoration on the first type of distortion and the second type of distortion, thereby reducing the difficulty of one-time restoration, and reducing the model development cost while improving the audio quality.

Based on the above embodiment, optionally, the first processing model includes a time domain restoration model and a frequency domain restoration model; the time domain restoration model is used to restore the first type of distortion in a first frequency band of the audio to be processed; and the frequency domain restoration model is used to restore the first type of distortion in a second frequency band of the audio to be processed.

Optionally, at least part of network layers of the time domain restoration model and/or the frequency domain restoration model are provided with dense connections.

Based on the above embodiment, optionally, the second processing model includes an encoding module, a temporal modeling module, an amplitude decoding module, and a phase decoding module, where the amplitude decoding module is used to predict an amplitude spectrum of the second restored audio; and the phase decoding module is used to predict a phase spectrum of the second restored audio.

Based on the above embodiment, optionally, the apparatus further includes: a model training module, configured to acquire undamaged audio and obtain damaged audio by processing the first type of distortion and/or the second type of distortion for the undamaged audio data; freeze model parameters of the second processing model, cascade the first processing model and the second processing model, and train the first processing model in a cascade model based on the damaged audio and the undamaged audio; and freeze model parameters of the trained first processing model, cascade the trained first processing model and the trained second processing model, and train the second processing model in the cascade model based on the damaged audio and the undamaged audio.

Optionally, the model training module is further configured to obtain the first processing model or the second processing model by iteratively performing the following training process until the training termination condition is satisfied: inputting the damaged audio into the cascaded first processing model and second processing model to obtain first predicted restored audio output by the first processing model and second predicted restored audio output by the second processing model; generating one or more of the following loss functions based on the first predicted restored audio and/or the second predicted restored audio, as well as the undamaged audio: discrimination loss functions, a generative loss function, a signal-to-noise ratio loss function, and a spectral compression loss function; and adjusting the parameters of the first processing model or the second processing model based on one or more of the discrimination loss functions, the generative loss function, the signal-to-noise loss function, and the spectral compression loss function.

Optionally, a discrimination loss function generation process includes: obtaining discrimination results of the plurality of discriminators by discriminating, based on a plurality of discriminators, the first predicted restored audio and/or the second predicted restored audio, and obtaining a plurality of discrimination loss functions based on the discrimination results of the plurality of discriminators;
the generative loss function is determined based on a discrimination result of at least one discriminator for the first predicted restored audio and/or the second predicted restored audio, as well as a discrimination result of the at least one discriminator for the undamaged audio;
the signal-to-noise ratio loss function is determined based on waveform data of the second predicted restored audio and waveform data of the undamaged audio; and
the spectral compression loss function is determined based on spectrum data of the second predicted restored audio and spectrum data of the undamaged audio.

The audio processing apparatus provided in this embodiment of the present disclosure may perform the audio processing method provided in any embodiment of the present disclosure, and has the corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

FIG. 6 is a schematic diagram of a structure of an electronic device according to an embodiment of the present disclosure. Reference is made to FIG. 6 below, which is a schematic diagram of a structure of an electronic device (e.g., a terminal device or a server in FIG. 6) 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit and a graphics processing unit) 601, which may perform various appropriate actions and processing according to a program stored on a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Typically, the following apparatuses may be connected to the I/O interface 605: an input apparatus 606, including, for example, a touchscreen, a touchpad, a keyboard, a mouse, a camera, a microphone, an accelerometer, and a gyroscope; an output apparatus 607, including, for example, a liquid crystal display (LCD), a speaker, and a vibrator; the storage apparatus 608, including, for example, a magnetic tape and a hard drive; and a communication apparatus 609. The communication apparatus 609 may allow the electronic device 600 to be in wireless or wired communication with other devices for data exchange. Although FIG. 6 illustrates the electronic device 600 with various apparatuses, it should be understood that it is not necessary to implement or have all the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 609, installed from the storage apparatus 608, or installed from the ROM 602. The computer program, when executed by the processing apparatus 601, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the audio processing method provided in the above embodiment belong to the same inventive concept, and for technical details not described in detail in this embodiment, reference may be made to the above embodiment. This embodiment and the above embodiment have the same beneficial effects.

An embodiment of the present disclosure provides a computer storage medium, storing a computer program. The program, when executed by a processor, implements the audio processing method provided in the above embodiment.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to: acquire audio to be processed, and restore a first type of distortion in the audio to be processed based on a first processing model to obtain first restored audio; and restore a second type of distortion in the first restored audio based on a second processing model to obtain second restored audio.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented through software or hardware. The name of the unit does not constitute a limitation on the unit itself in some cases. For example, a first acquiring unit may also be described as “a unit for acquiring at least two Internet protocol addresses”.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, [Example 1] provides an audio processing method, including:
acquiring audio to be processed, and obtaining first restored audio by restoring, based on a first processing model, a first type of distortion in the audio to be processed; and
restoring a second type of distortion in the first restored audio based on a second processing model to obtain second restored audio.

According to one or more embodiments of the present disclosure, [Example 2] provides the audio processing method according to Example 1, further including:

the first processing model including a time domain restoration model and a frequency domain restoration model; the time domain restoration model being used to restore the first type of distortion in a first frequency band of the audio to be processed; and the frequency domain restoration model being used to restore the first type of distortion in a second frequency band of the audio to be processed.

According to one or more embodiments of the present disclosure, [Example 3] provides the audio processing method according to Example 1, further including:
at least part of network layers of the time domain restoration model and/or the frequency domain restoration model being provided with dense connections.

According to one or more embodiments of the present disclosure, [Example 4] provides the audio processing method according to Example 1, further including:
the second processing model including an encoding module, a temporal modeling module, an amplitude decoding module, and a phase decoding module, where the amplitude decoding module is used to predict an amplitude spectrum of the second restored audio; and the phase decoding module is used to predict a phase spectrum of the second restored audio.

According to one or more embodiments of the present disclosure, [Example 5] provides the audio processing method according to Example 1, further including:
a method for training the first processing model and the second processing model including: acquiring undamaged audio and obtaining damaged audio by processing the first type of distortion and/or the second type of distortion for the undamaged audio data; freezing model parameters of the second processing model, cascading the first processing model and the second processing model, and training the first processing model in a cascade model based on the damaged audio and the undamaged audio; and freezing model parameters of the trained first processing model, cascading the trained first processing model and the trained second processing model, and training the second processing model in the cascade model based on the damaged audio and the undamaged audio.

According to one or more embodiments of the present disclosure, [Example 6] provides the audio processing method according to Example 1, further including:
the process of training the first processing model or the second processing model including: obtaining the first processing model or the second processing model by iteratively performing the following training process until the training termination condition is satisfied: inputting the damaged audio into the cascaded first processing model and second processing model to obtain first predicted restored audio output by the first processing model and second predicted restored audio output by the second processing model; generating one or more of the following loss functions based on the first predicted restored audio and/or the second predicted restored audio, as well as the undamaged audio: discrimination loss functions, a generative loss function, a signal-to-noise ratio loss function, and a spectral compression loss function; and adjusting the parameters of the first processing model or the second processing model based on one or more of the discrimination loss functions, the generative loss function, the signal-to-noise loss function, and the spectral compression loss function.

According to one or more embodiments of the present disclosure, [Example 7] provides the audio processing method according to Example 1, further including:
the generation process of the generation process discrimination loss function including: obtaining discrimination results of the plurality of discriminators by discriminating, based on a plurality of discriminators, the first predicted restored audio and/or the second predicted restored audio, and obtaining a plurality of discrimination loss functions based on the discrimination results of the plurality of discriminators;
the generative loss function being determined based on a discrimination result of at least one discriminator for the first predicted restored audio and/or the second predicted restored audio, as well as a discrimination result of the at least one discriminator for the undamaged audio;
the signal-to-noise ratio loss function being determined based on waveform data of the second predicted restored audio and waveform data of the undamaged audio; and
the spectral compression loss function being determined based on spectrum data of the second predicted restored audio and spectrum data of the undamaged audio.

According to one or more embodiments of the present disclosure, [Example 8] provides an audio processing apparatus, including:
a first restoration module, configured to acquire audio to be processed, and restore a first type of distortion in the audio to be processed based on a first processing model to obtain first restored audio; and
a second restoration module, configured to restore a second type of distortion in the first restored audio based on a second processing model to obtain second restored audio.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. An audio processing method, comprising:
acquiring audio to be processed, and obtaining first restored audio by restoring, based on a first processing model, a first type of distortion in the audio to be processed; and
obtaining second restored audio by restoring, based on a second processing model, a second type of distortion in the first restored audio.

2. The method of claim 1, wherein the first processing model comprises a time domain restoration model and a frequency domain restoration model; the time domain restoration model is used to restore the first type of distortion in a first frequency band of the audio to be processed; and the frequency domain restoration model is used to restore the first type of distortion in a second frequency band of the audio to be processed.

3. The method of claim 2, wherein at least part of network layers of the time domain restoration model and/or the frequency domain restoration model are provided with dense connections.

4. The method of claim 1, wherein the second processing model comprises an encoding module, a temporal modeling module, an amplitude decoding module, and a phase decoding module, and wherein the amplitude decoding module is used to predict an amplitude spectrum of the second restored audio; and the phase decoding module is used to predict a phase spectrum of the second restored audio.

5. The method of claim 1, wherein the first type of distortion is a missing distortion, and the second type of distortion is an additive distortion.

6. The method of claim 1, wherein a method for training the first processing model and the second processing model comprises:
acquiring undamaged audio and obtaining damaged audio by processing the first type of distortion and/or the second type of distortion for the undamaged audio data;
freezing model parameters of the second processing model, cascading the first processing model and the second processing model, and training the first processing model in a cascade model based on the damaged audio and the undamaged audio; and
freezing model parameters of the trained first processing model, cascading the trained first processing model and the trained second processing model, and training the second processing model in the cascade model based on the damaged audio and the undamaged audio.

7. The method of claim 6, wherein the process of training the first processing model or the second processing model comprises:
obtaining the first processing model or the second processing model by iteratively performing the following training process until a training termination condition is satisfied: inputting the damaged audio into the cascaded first processing model and second processing model to obtain first predicted restored audio output by the first processing model and second predicted restored audio output by the second processing model;
generating one or more of the following loss functions based on the first predicted restored audio and/or the second predicted restored audio, as well as the undamaged audio: discrimination loss functions, a generative loss function, a signal-to-noise ratio loss function, and a spectral compression loss function; and
adjusting the parameters of the first processing model or the second processing model based on one or more of the discrimination loss functions, the generative loss function, the signal-to-noise loss function, and the spectral compression loss function.

8. The method of claim 7, wherein a discrimination loss function generation process comprises: obtaining discrimination results of the plurality of discriminators by discriminating, based on a plurality of discriminators, the first predicted restored audio and/or the second predicted restored audio, and obtaining a plurality of discrimination loss functions based on the discrimination results of the plurality of discriminators;
the generative loss function is determined based on a discrimination result of at least one discriminator for the first predicted restored audio and/or the second predicted restored audio, as well as a discrimination result of the at least one discriminator for the undamaged audio;
the signal-to-noise ratio loss function is determined based on waveform data of the second predicted restored audio and waveform data of the undamaged audio; and
the spectral compression loss function is determined based on spectrum data of the second predicted restored audio and spectrum data of the undamaged audio.

9. An electronic device, comprising:
one or more processors; and
a storage apparatus, configured to store one or more programs, wherein
the one or more programs, when executed by the one or more processors, cause the one or more processors to:
acquire audio to be processed, and obtain first restored audio by restoring, based on a first processing model, a first type of distortion in the audio to be processed; and
obtain second restored audio by restoring, based on a second processing model, a second type of distortion in the first restored audio.

10. The electronic device of claim 9, wherein the first processing model comprises a time domain restoration model and a frequency domain restoration model; the time domain restoration model is used to restore the first type of distortion in a first frequency band of the audio to be processed; and the frequency domain restoration model is used to restore the first type of distortion in a second frequency band of the audio to be processed.

11. The electronic device of claim 10, wherein at least part of network layers of the time domain restoration model and/or the frequency domain restoration model are provided with dense connections.

12. The electronic device of claim 9, wherein the second processing model comprises an encoding module, a temporal modeling module, an amplitude decoding module, and a phase decoding module, and wherein the amplitude decoding module is used to predict an amplitude spectrum of the second restored audio; and the phase decoding module is used to predict a phase spectrum of the second restored audio.

13. The electronic device of claim 9, wherein the first type of distortion is a missing distortion, and the second type of distortion is an additive distortion.

14. The electronic device of claim 9, wherein a method for training the first processing model and the second processing model comprises:
acquiring undamaged audio and obtaining damaged audio by processing the first type of distortion and/or the second type of distortion for the undamaged audio data;
freezing model parameters of the second processing model, cascading the first processing model and the second processing model, and training the first processing model in a cascade model based on the damaged audio and the undamaged audio; and
freezing model parameters of the trained first processing model, cascading the trained first processing model and the trained second processing model, and training the second processing model in the cascade model based on the damaged audio and the undamaged audio.

15. The electronic device of claim 14, wherein the process of training the first processing model or the second processing model comprises:
obtaining the first processing model or the second processing model by iteratively performing the following training process until a training termination condition is satisfied: inputting the damaged audio into the cascaded first processing model and second processing model to obtain first predicted restored audio output by the first processing model and second predicted restored audio output by the second processing model;
generating one or more of the following loss functions based on the first predicted restored audio and/or the second predicted restored audio, as well as the undamaged audio: discrimination loss functions, a generative loss function, a signal-to-noise ratio loss function, and a spectral compression loss function; and
adjusting the parameters of the first processing model or the second processing model based on one or more of the discrimination loss functions, the generative loss function, the signal-to-noise loss function, and the spectral compression loss function.

16. The electronic device of claim 15, wherein a discrimination loss function generation process comprises: obtaining discrimination results of the plurality of discriminators by discriminating, based on a plurality of discriminators, the first predicted restored audio and/or the second predicted restored audio, and obtaining a plurality of discrimination loss functions based on the discrimination results of the plurality of discriminators;
the generative loss function is determined based on a discrimination result of at least one discriminator for the first predicted restored audio and/or the second predicted restored audio, as well as a discrimination result of the at least one discriminator for the undamaged audio;
the signal-to-noise ratio loss function is determined based on waveform data of the second predicted restored audio and waveform data of the undamaged audio; and
the spectral compression loss function is determined based on spectrum data of the second predicted restored audio and spectrum data of the undamaged audio.

17. A non-transitory storage medium comprising computer-executable instructions, wherein the computer-executable instructions, when executed by a computer processor, cause the computer processor to:
acquire audio to be processed, and obtain first restored audio by restoring, based on a first processing model, a first type of distortion in the audio to be processed; and
obtain second restored audio by restoring, based on a second processing model, a second type of distortion in the first restored audio.

18. The non-transitory storage medium of claim 17, wherein the first processing model comprises a time domain restoration model and a frequency domain restoration model; the time domain restoration model is used to restore the first type of distortion in a first frequency band of the audio to be processed; and the frequency domain restoration model is used to restore the first type of distortion in a second frequency band of the audio to be processed.

19. The non-transitory storage medium of claim 18, wherein at least part of network layers of the time domain restoration model and/or the frequency domain restoration model are provided with dense connections.

20. The non-transitory storage medium of claim 17, wherein the second processing model comprises an encoding module, a temporal modeling module, an amplitude decoding module, and a phase decoding module, and wherein the amplitude decoding module is used to predict an amplitude spectrum of the second restored audio; and the phase decoding module is used to predict a phase spectrum of the second restored audio.
